(19) United States
(12) Patent Application Publication
(10) Pub. No.: US 2015/0371091 A1
(43) Pub. Date: Dec. 24, 2015

(54) SYSTEM AND METHOD FOR IDENTIFYING A CLOTHING ARTIFACT

(71) Applicant: Cortica, Ltd., TEL AVIV (IL)

(72) Inventors: Igal Raichelgauz, New York, NY (US); Karina Odinaev, New York, NY (US); Yehoshua Y. Zeevi, Haifa (IL)

(73) Assignee: Cortica, Ltd., TEL AVIV (IL)

(21) Appl. No.: 14/836,249

(22) Filed: Aug. 26, 2015

Related U.S. Application Data
(63) Continuation-in-part of application No. 14/096,865, filed on Dec. 4, 2013.
Application No. 14/096,865 is a continuation-in-part of application No. 13/624,397, filed on Sep. 21, 2012.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/042,797, filed on Aug. 28, 2014.
(60) Provisional application No. 61/890,251, filed on Oct. 13, 2013.

(30) Foreign Application Priority Data
Oct. 26, 2005 (IL) 171577
Jan. 29, 2006 (IL) 173409
Aug. 21, 2007 (IL) 185414

(51) Int. Cl. G06K 9/00; G06K 9/62; G06F 17/30; G06K 9/46

(52) U.S. Cl. CPC G06K 9/00744; G06K 9/4652; G06K 9/6201; G06F 17/30256

(57) ABSTRACT

A system and method for identifying metadata for clothing artifacts that appear in multimedia content items are presented. The method includes generating at least one signature for a received multimedia content item; identifying at least one matching concept to the multimedia content item, wherein the identification is based on signature matching between the at least one generated signature and a plurality of concept signatures representing a concept; matching each concept signature to previously generated signatures associated with clothing artifacts; and identifying, for each clothing artifact signature, metadata associated with the clothing artifact signature.

### CROSS-REFERENCE TO RELATED APPLICATIONS

This application claims the benefit of U.S. provisional application No. 62/042,797 filed on Aug. 28, 2014. This application is also a continuation-in-part (CIP) of U.S. patent application Ser. No. 14/096,865 filed Dec. 4, 2013, now pending, which claims the benefit of U.S. provisional application No. 61/890,251 filed Oct. 13, 2013. The Ser. No. 14/096,865 application is a continuation-in-part (CIP) of U.S. patent application Ser. No. 13/624,397 filed on Sep. 21, 2012, now allowed. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221, filed May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference for all that they contain.

### TECHNICAL FIELD

The present invention relates generally to the analysis of multimedia content items, and more specifically to techniques for identifying metadata related to clothing artifacts appearing in multimedia content items.

### BACKGROUND

The World Wide Web (WWW) contains a variety of information associated with clothes and fashion. Such information is commonly used by designers, fashion-professionals, and any other people who are interested in fashion. Such people commonly use a variety of web platforms to gain knowledge and ideas about how to dress. The knowledge can be used, for example, to assist in color matching different clothing artifacts (i.e., items of clothing) or to purchase clothing artifacts that are considered fashionable for a certain time period.

Currently, many web platforms such as websites, web applications, and mobile applications (“apps”), are designed to provide information related to fashion. For example, a variety of e-commerce websites provide applications that assist users with tracking matching clothing items, fashionable items, items that are on sale, etc. However, if the user deviates from a certain web-site and wishes to track such items in other websites, the existing solutions typically will not be capable of factoring in these preferences. Thus, the methods used to track relevant data by existing solutions may not be optimal

It would be therefore advantageous to provide an efficient solution to identify clothing artifacts available either offline or online. It would be further advantageous if such a solution would provide data respective thereof.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all aspects nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

The disclosed embodiments include a method for identifying metadata for clothing artifacts that appear in multimedia content items. The method comprises: generating at least one signature for a received multimedia content item; identifying at least one matching concept to the multimedia content item, wherein the identification is based on signature matching between the at least one generated signature and a plurality of concept signatures representing a concept; matching each concept signature to previously generated signatures associated with clothing artifacts; and identifying, for each clothing artifact signature, metadata associated with the clothing artifact signature.

The disclosed embodiments also include a system for identifying metadata for clothing artifacts that appear in multimedia content items. The system comprises: a processing unit; and a memory connected to the processing unit, wherein the memory contains instructions that, when executed by the processing unit, configure the system to: generate at least one signature for a received multimedia content item; match concept to the multimedia content item, wherein the identification is based on signature matching between the at least one generated signature and a plurality of concept signatures representing a concept; match each concept signature to previously generated signatures associated with clothing artifacts; and identify, for each clothing artifact signature, metadata associated with the clothing artifact signature.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a network system utilized to describe the various embodiments disclosed herein.

FIG. 2 is a flowchart describing the process of identifying a clothing artifact according to an embodiment.

FIG. 3 is a block diagram depicting the basic flow of information in the signature generator system.

FIG. 4 is a diagram showing the flow of patches generation, response vector generation, and signature generation in a large-scale speech-to-text system;

FIG. 5 is a diagram of a DCC system for creating concept structures according to an embodiment.

FIG. 6 is a flowchart describing the process for selecting metadata based on user preferences according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein include a method for identifying metadata associated with clothing artifacts appear in a multimedia content item. The multimedia content item in which the clothing artifact is shown is received from a user device. At least one signature is generated for the clothing artifact and the generated signature(s) are matched to at least one previously generated signature maintained in a data warehouse. The clothing artifact(s) are identified based on matching at least one newly generated signature to at least one previously generated signature. Accordingly, metadata respective to the clothing artifacts is extracted from the data warehouse and sent to the user device. The metadata may include commercial data such as, for example, where to buy the clothing artifact, its price, its brand, and so on. According to another embodiment, the metadata may include visual data respective of the clothing artifacts such as, for example, its color, size, model name, and so on.

In an embodiment, the clothing artifacts in the multimedia content item can be identified based on identification of concepts. In another embodiment, the metadata sent to the user device may be in accordance with one or more of the user's preferences. As an example, when a user prefers a certain type of fabric (e.g., organic cotton), the metadata provided to the user may be optimized to that specific type of fabric (i.e., the metadata may be concentrated around clothing artifacts made of organic cotton). Accordingly, users receive information appropriate to their respective requirements.

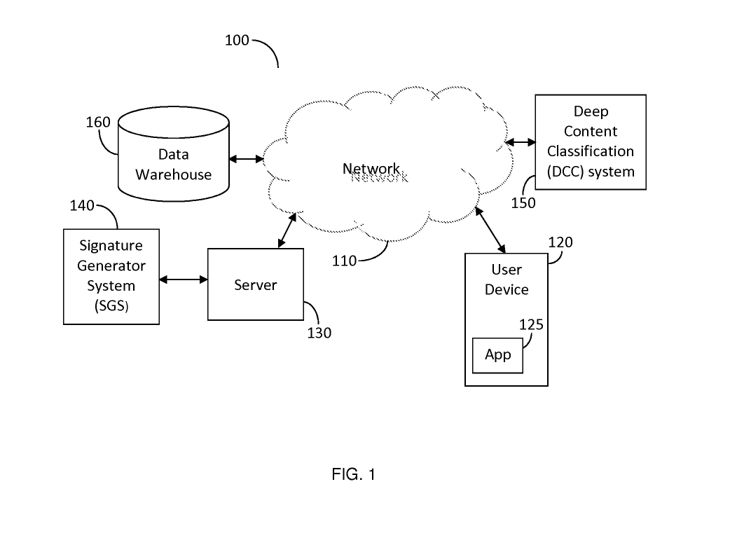

FIG. 1 shows an exemplary and non-limiting schematic diagram of a network system 100 utilized to describe the various embodiments disclosed herein. A network 110 is used to communicate between different parts of the network system 100. The network 110 may be the Internet, the world-wide-web (WWW), a local area network (LAN), a wide area network (WAN), a metro area network (MAN), and any other network capable of enabling communication between elements of the system 100.

Further connected to the network 110 is a user device 120 configured to execute at least one application (“app”) 125. The application 125 may be, for example, a web browser, a script, an add-on, a mobile application, or any application programmed to interact with a server 130. The user device 120 may be, but is not limited to, a personal computer (PC), a personal digital assistant (PDA), a mobile phone, a smart phone, a tablet computer, a laptop, a wearable computing device, or another kind of computing device equipped with browsing, viewing, listening, filtering, and managing capabilities that is enabled as further discussed herein below. It should be noted that one user device 120 and one application 125 are illustrated in FIG. 1 merely for the sake of simplicity and without limitation on the generality of any of the disclosed embodiments.

The network system 100 also includes a data warehouse 160 configured to store at least one multimedia content item in which a clothing artifact(s) is shown, previously generated signatures of clothing artifacts, metadata related to certain clothing artifacts, and the like. In the embodiment illustrated in FIG. 1, the server 130 communicates with the data warehouse 160 through the network 110. In other non-limiting configurations, the server 130 is directly connected to the data warehouse 160.

The various embodiments disclosed herein are realized using the server 130, a signature generator system (SGS) 140 and a deep-content-classification (DCC) system 150. The SGS 140 may be connected to the server 130 directly or through the network 110. The server 130 is configured to receive and serve the at least one multimedia content item in which objects are shown and cause the SGS 140 to generate at least one signature respective thereof and query the DCC system 150. To this end, the server 130 is communicatively connected to the SGS 140 and the DCC system 150. The DCC system 150 may be further connected to the network 110.

The DCC system 150 is configured to generate concept structures (or concepts) and to identify concepts that match the objects. A concept is a collection of signatures representing an object and metadata describing the concept. The collection is a signature reduced cluster generated by inter-matching the signatures generated for the many objects, clustering the inter-matched signatures, and providing a reduced cluster set of such clusters. As a non-limiting example, a ‘Superman concept’ is a signature reduced cluster of signatures describing elements (such as objects) related to, e.g., a Superman cartoon: a set of metadata including textual representations of the Superman concept.

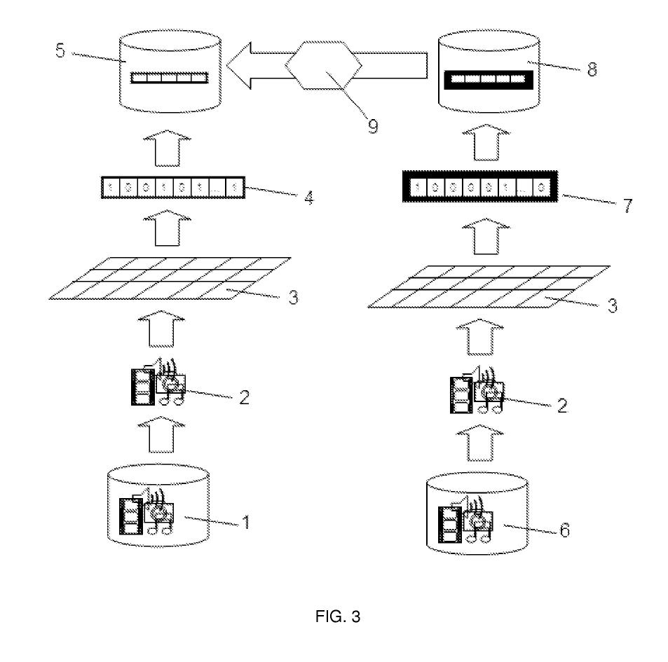

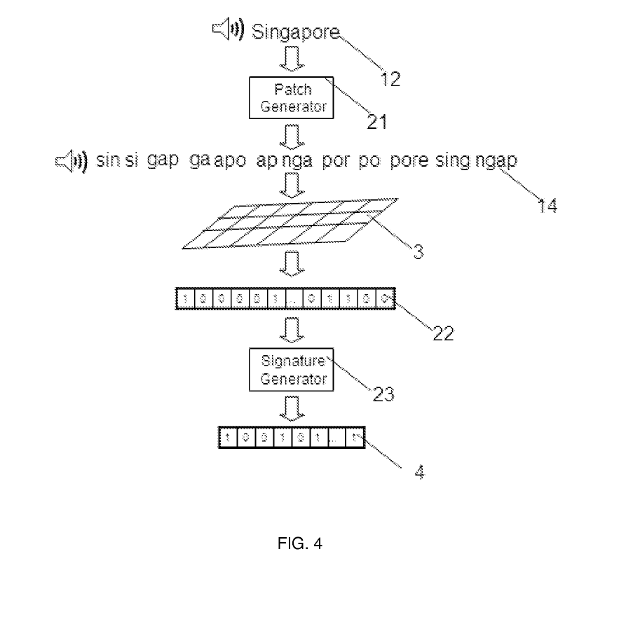

Techniques for generating concepts and concept structures are also described in the U.S. Pat. No. 8,266,185 (hereinafter the '185 patent) to Raichelgauz, et al., assigned to a common assignee, which is hereby incorporated by reference for all that it contains. In an embodiment, the DCC system 150 is configured and operates as the DCC system discussed in the '185 patent. The process of generating the signatures in the SGS 140 is explained in more detail below with respect to FIGS. 3 and 4.

It should be noted that each of the server 130, the SGS 140, and the DCC system 150 typically comprise a processing unit, such as a processor (not shown) or an array of processors coupled to a memory. In one embodiment, the processing unit may be realized through architecture of computational cores described in detail below. The memory contains instructions that can be executed by the processing unit. The instructions, when executed by the processing unit, cause the processing unit to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The server 130 also includes an interface (not shown) to the network 110.

According to the disclosed embodiments, the server 130 is configured to receive a multimedia content item showing clothing artifacts from the user device 120. The multimedia content item may be, but is not limited to, an image, a graphic, a video stream, a video clip, a video frame, a photograph, and/or combinations thereof and portions thereof. In one embodiment, the server 130 is configured to receive a URL of a web-page viewed by the user device 120 and accessed by the application 125. The web-page is processed to extract the multimedia content item contained therein. The request to analyze the multimedia content item can be sent by a script executed in the web-page such as the application 125 (e.g., a web server or a publisher server) when requested to upload one or more multimedia content items to the web-page. Such a request may include a URL of the web-page or a copy of the web-page. The application 125 can also send a picture or a video clip taken by a user of the user device 120 to the server 130.

The request to analyze the multimedia content item can be sent by a script executed in the webpage such as the application 125 (e.g., a web server or a publisher server) when requested to upload one or more multimedia content items to the webpage. Such a request may include a URL of the webpage or a copy of the webpage. The application 125 can also send a picture taken by a user of the user device 120 to the server 130.

In response to receiving the multimedia content item, the server 130 is configured to return metadata respective of the clothing artifacts shown in the displayed item. To this end, the server 130 is configured to analyze the multimedia content item to identify portions or multimedia elements in the multimedia content item containing the clothing artifacts. As an example, consider a picture showing a man wearing a polo shirt designed by Ralph Lauren®. For purposes of gathering metadata, only the polo shirt multimedia element (not a multimedia element of the man) is relevant. At least one signature is generated for each relevant multimedia element (i.e., an element that contains the polo shirt) using the SGS 140. The generated signature(s) may be robust to noise and distortion as discussed below.

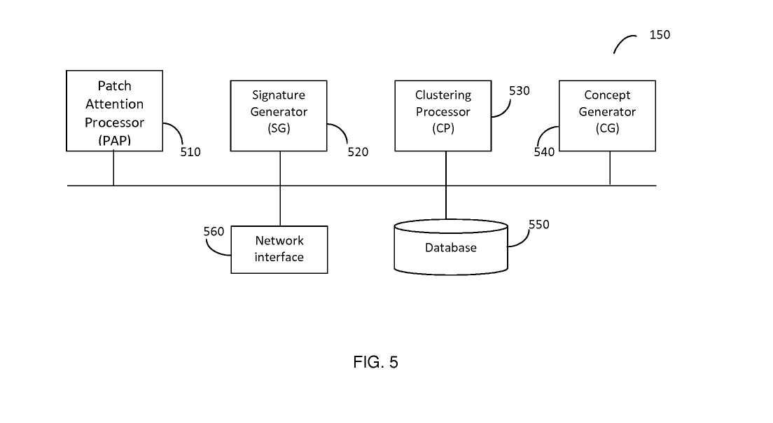

In one embodiment, using the generated signature(s), the DCC system 150 is configured to receive a query to determine if there is a match to at least one concept of clothing artifact(s). In an embodiment, the DCC system 150 is configured to return, for each matching concept, the concept's signature (signature reduced cluster (SRC)) and, optionally, the concept's metadata. Using the SRC of the matching concept, the server 130 is configured to determine metadata associated with the matching concept. Specifically, when one match is identified, the server 130 is configured to retrieve from the data warehouse 160 and send metadata associated with the clothing artifacts to the user device 120. Operation of the DCC system 150 is described further herein below with respect to FIG. 5.

According to another embodiment, the determination of at least one concept of clothing artifact may be made based on body parts associated with the clothing artifact. For example, a concept of a ring is determined if it appears on an element that is determined as a finger. As another example, if a clothing artifact is on an element that is determined as a foot, a concept is identified that is any of: a shoe, a sock, a sandal, and so on.

In another embodiment, the SGS 140 is configured to generate signatures for the clothing artifacts shown in the received multimedia content item. The server 130 is configured to match the generated signatures to previously generated signatures of concepts maintained in the data warehouse 160 to identify at least one clothing artifact that matches at least one concept. When at least one match is identified, the server 130 is configured to retrieve metadata related to those clothing artifacts from the data warehouse 160. The metadata is then sent to the user device 120.

In yet another embodiment, the server 130 is configured to receive, from the user device 120, one or more inputs related to the users clothing artifacts or to the requested metadata. The server 130 is further configured to analyze the inputs and provide a user of the user device 120 with metadata respective thereof. As an example, the user may prefer to receive metadata related to similar clothing artifacts within a determined budget. As another example, a user located in Italy would prefer to receive data regarding places to purchase a clothing artifact that delivers to, is located in, or manufactures their clothing in Italy.

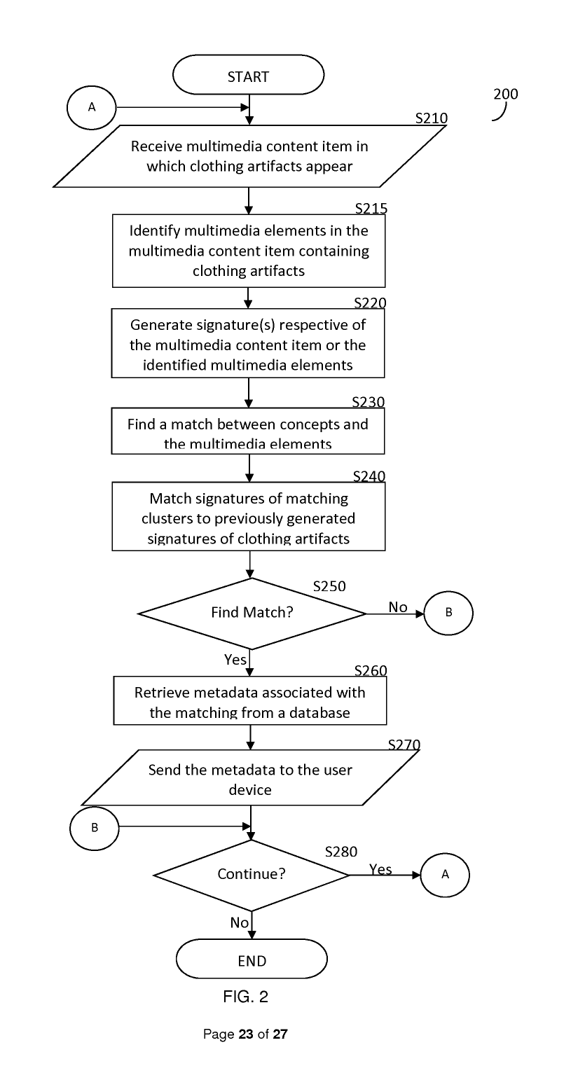

FIG. 2 depicts an exemplary and non-limiting flowchart 200 describing a method for providing metadata of clothing artifacts shown in multimedia content items according to an embodiment. In an embodiment, the method may be performed by the server 130.

In S210, a multimedia content item in which clothing artifacts appear is received. In an embodiment, the multimedia content item is received together with the user's preferences and/or a type of metadata the user is interested in.

Optionally, in S215, the received multimedia content item is analyzed to identify multimedia elements of interest, wherein each identified multimedia element of interest contains a potential clothing artifact. In an embodiment, the analysis to identify multimedia elements may be performed by, but is not limited to, a patch attention processor (PAP).

The PAP creates a plurality of patches from the received multimedia content item. A patch of an image is defined by, for example, its size, scale, location, and orientation, and may be, but is not limited to, a portion (of a size of 20 pixels by 20 pixels) of an image of a size 1,000 pixels by 500 pixels. A patch of audio content may be a segment of audio 0.5 seconds in length from a 5 minute audio clip. Each patch is analyzed to determine its entropy, wherein the entropy is a measure of the amount of interesting information that may be present in the patch. For example, a continuous color of the patch has little interest while sharp edges, corners or borders, will result in higher entropy representing a lot of interesting information. The plurality of statistically independent cores, the operation of which is discussed in more detailed herein below, is used to determine the level-of-interest of the image and a process of voting takes place to determine whether the patch is of interest or not. If the entropy for a particular patch is above a predefined interest threshold, the multimedia element existing in the patch may be determined to be of interest and, therefore, may be determined to contain a potential clothing artifact. Patch processing is described further in the '185 application.

In S220, at least one signature is generated for the received multimedia content item or for the identified multimedia element(s). The signatures are generated by the SGS 140 as described in greater detail below with respect to FIGS. 3 and 4.

In S230, a DCC system (e.g., the DCC system 150) is queried to find a match between at least one concept and the received multimedia content item or the generated multimedia elements using their respective signatures. In an embodiment, at least one signature generated for a multimedia content item or multimedia element is matched against the signature (signature reduced cluster (SRC)) of each concept maintained by the DCC system. If the signature of the concept overlaps with the signature of the multimedia content item or multimedia element above a predetermined threshold level, a match exists. Various techniques for determining matching concepts are discussed in the '185 patent. For each matching concept, the respective multimedia content item or multimedia element is determined to be identified and at least the concept signature (SRC) is returned.

In S240, signatures (SRCs) of matching clusters are matched to previously generated signatures of clothing artifacts maintained in a database (e.g., the data warehouse 160). In another embodiment, if matching concepts are not found, the signatures generated at S220 are utilized to search the database.

In S250, it is checked whether a match can be found in the database and, if so, execution continues with S260; otherwise, execution continues with S280. In S260, the metadata associated with each matching signature is retrieved from the database. The metadata includes, for example, visual data related to the clothing artifact, such as: color, size, model name, and so on. Model name may be a general model name (e.g., “hat,” “pants,” “shirt,” “coat,” and so on) or a specific model name (e.g., “baseball cap,” “jeans,” “polo shirt,” “sweatshirt jacket,” and so on). According to another embodiment, the metadata may include commercial data related to the clothing artifact such as, for example, data regarding places to purchase the artifact, a brand of the artifact, the artifact's typical or average price, etc.

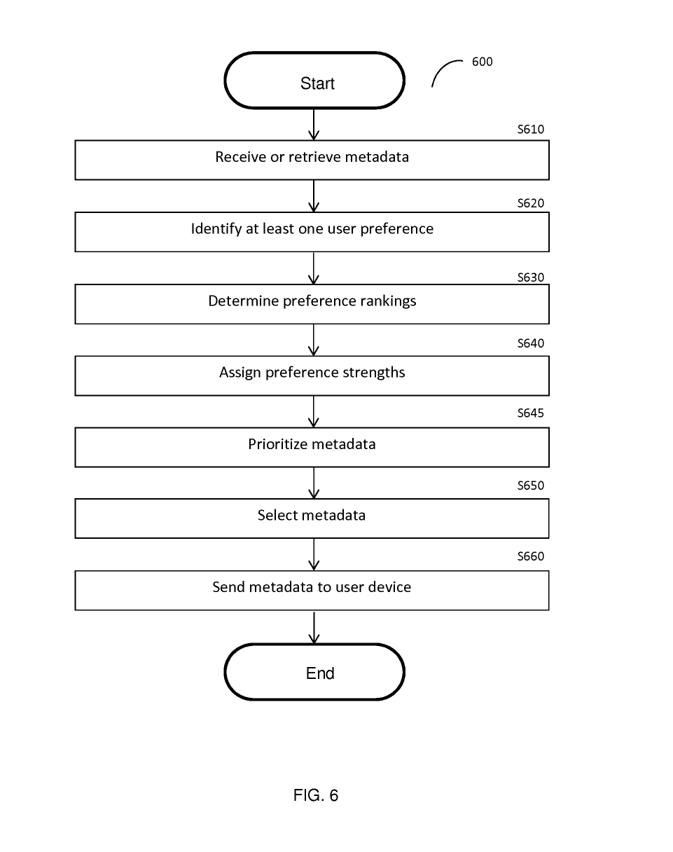

In S270, the metadata is sent to a user device (e.g., the user device 120). In an embodiment, only select metadata is sent to the user device. The metadata to be sent may be selected based on, e.g., at least one user preference. Selecting metadata of clothing artifacts based on user preferences is described further herein below with respect to FIG. 6. In S280, it is checked whether additional multimedia content items have been received, and if so, execution continues with S210; otherwise, execution terminates.

As a non-limiting example, an image multimedia content item displaying a woman's face is received, wherein the woman is wearing sunglasses. Based on a patch analysis of the image, the multimedia elements of the sunglasses and the hat are identified. Signatures are generated respective of the sunglasses and hat multimedia elements. Each generated signature is matched to every SRC stored in a DCC system. It is determined that the SRCs of the concepts “sunglasses” and “hats,” respectively, match the generated signatures above a predefined threshold. Signatures of the matching concepts are matched to signatures of known clothing artifacts existing in a database. Metadata associated with each matching clothing artifact signature is retrieved from the database and sent to the user device. In this example, metadata for the “sunglasses” concept includes

[symbol]

FIGS. 3 and 4 illustrate the generation of signatures for the multimedia content elements by the SGS 140 according to one embodiment. An exemplary high-level description of the process for large scale matching is depicted in FIG. 4. In this non-limiting example, the matching is conducted based on video content.

Video content segments 2 from a Master database (DB) 6 and a Target DB 1 are processed in parallel by a large number of independent computational cores 3 that constitute an architecture for generating the signatures (hereinafter the “Architecture”). Further details on the generation of computational cores are provided below. The independent cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 5. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing dynamics in-between the frames.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P, and random position parameters is determined based on optimization, considering the tradeoff between accuracy rate and the number of fast matches required in the flow process of the server 130 and SGS 140. Thereafter, all the K patches are injected in parallel into all computational cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the computational cores 3 a frame ‘i’ is injected into all the cores 3. Then, cores 3 generate two binary response vectors: S, which is a Signature vector, and RS which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = Π ( {V}_{i} - {TH}_{x} )$$

where, [symbol] is a Heaviside step function; wᵢⱼ is a coupling node unit (CNU) between node i and image component j (for example, grayscale value of a certain pixel j); kⱼ is an image component ‘j’ (for example, grayscale value of a certain pixel j); THₓ is a constant Threshold value, where ‘x’ is ‘S’ for Signature and ‘RS’ for Robust Signature; and Vi is a Coupling Node Value.

The Threshold values Th_{X} are set differently for Signature generation than for Robust Signature generation. For example, for a certain distribution of Vi values (for the set of nodes), the thresholds for Signature (Th_{S}) and Robust Signature (Th_{RS}) are set apart, after optimization, according to at least one or more of the following criteria:
1: For:

Vᵢ>Th_{RS}

1−p(V>Th_{S})−1−(1−ε)¹<<1

i.e., given that I nodes (cores) constitute a Robust Signature of a certain image I, the probability that not all of these I nodes will belong to the Signature of same, but noisy image, Ĩ is sufficiently low (according to a system's specified accuracy).
2:

p(Vᵢ>Th_{RS})≈l/L

i.e., approximately I out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need for comparison to the original data. The detailed description of the signature generation can be found in U.S. Pat. Nos. 8,326,775 and 8,312,031, assigned to common assignee, which are hereby incorporated by reference for all the useful information they contain.

A computational core generation is a process of definition, selection, and tuning of the parameters of the cores for a certain realization in a specific system and application. The process is based on several design considerations, such as:

(a) The cores should be designed so as to obtain maximal independence, i.e., the projection from a signal space should generate a maximal pair-wise distance between any two cores' projections into a high-dimensional space.

(b) The cores should be optimally designed for the type of signals, i.e., the cores should be maximally sensitive to the spatio-temporal structure of the injected signal, for example, and in particular, sensitive to local correlations in time and space. Thus, in some cases, a core represents a dynamic system, such as in state space, phase space, edge of chaos, etc., which is uniquely used herein to exploit its maximal computational power.

(c) The cores should be optimally designed with regard to invariance to a set of signal distortions, of interest in relevant applications.

A detailed description of the computational core generation and the process for configuring such cores is discussed in more detail in U.S. Pat. No. 8,655,801 referenced above.

FIG. 5 shows an exemplary and non-limiting diagram of a DCC system 150 for creating concept structures according to an embodiment. The DCC system 150 is configured to receive multimedia data elements (MMDEs), for example from the Internet via the network interface 560. The MMDEs include, but are not limited to, images, graphics, video streams, video clips, audio streams, audio clips, video frames, photographs, images of signals, combinations thereof, and portions thereof. The images of signals are images such as, but not limited to, medical signals, geophysical signals, subsonic signals, supersonic signals, electromagnetic signals, and infrared signals.

The MMDEs may be stored in a database (DB) 550 or kept in the database 550 for future retrieval of the respective multimedia data element. Such a reference may be, but is not limited to, a universal resource locator (URL). Every MMDE in the database 550, or referenced therefrom, is then processed by a patch attention processor (PAP) 510 resulting in a plurality of patches that are of specific interest, or otherwise of higher interest than other patches. A more general pattern extraction, such as an attention processor (AP) may also be used in lieu of patches. The AP receives the MMDE that is partitioned into items; an item may be an extracted pattern or a patch, or any other applicable partition depending on the type of the MMDE. The functions of the PAP 510 are described herein below in more detail.

Those patches that are of higher interest are then used by a signature generator (SG) 520 to generate signatures respective of the patch. Generation of signatures is described further herein above with respect to FIGS. 3 and 4. A clustering processor (CP) 530 initiates a process of inter-matching of the signatures once it determines that there are a number of patches that are above a predefined threshold. The threshold may be defined to be large enough to enable proper and meaningful clustering. With a plurality of clusters, a process of clustering reduction takes place so as to extract the most useful data about the cluster and keep it at an optimal size to produce meaningful results. The process of cluster reduction is continuous. When new signatures are provided after the initial phase of the operation of the CP 530, the new signatures may be immediately checked against the reduced clusters to save on the operation of the CP 130.

A concept generator (CG) 540 operates to create concept structures from the reduced clusters provided by the CP 530. Each concept structure comprises a plurality of metadata associated with the reduced clusters. The result is a compact representation of a concept that can now be easily compared against a MMDE to determine if the received MMDE matches a concept structure stored, for example in the DB 550, by the CG 540. This can be done, for example and without limitation, by providing a query to the DCC system 150 for finding a match between a concept structure and a MMDE.

It should be appreciated that the DCC system 150 can generate a number of concept structures significantly smaller than the number of MMDEs. For example, if one billion (10⁹) MMDEs need to be checked for a match against another one billion MMDEs, typically the result is that no less than 10⁹×10⁹=10¹⁸ matches have to take place, a daunting undertaking. The DCC system 150 would typically have around 10 million concept structures or less, and therefore at most only 2×10⁶×10⁹=2×10¹⁵ comparisons need to take place, a mere 0.2% of the number of matches that have had to be made by other solutions. As the number of concept structures grows significantly slower than the number of MMDEs, the advantages of the DCC system 150 would be apparent to one with ordinary skill in the art. Concepts, concept structures, and elements of the DCC 150 are described further in the '185 patent.

FIG. 6 is an exemplary and non-limiting flowchart 600 illustrating a method for selecting metadata based on user preferences according to an embodiment. In S610, metadata associated with at least one signature is received or retrieved. In S620, at least one user preference is identified. The identified at least one user preference may be received from a user device (e.g., the user device 120), or may be determined based on a user browsing and/or purchasing history. The determination may be made if, e.g., a particular feature of clothing appears above a certain threshold in the user's browsing and/or purchasing history. For example, if a user has previously browsed 100 hats, 60 of which were blue in color, a user preference for the feature “blue color” may be identified.

In S630, a preference ranking is determined for each user preference. The preference ranking shows the user's preference for a particular feature of a clothing artifact with respect to similar features (e.g., the user may prefer button down shirts to polo shirts, the user may prefer blue clothes to green clothes, the user prefers cotton to leather, and so on) and may be, but is not limited to, a numerical value (e.g., an integer on a scale from 1 to 10).

In S640, the metadata is assigned at least one preference strength based on a degree to which the metadata is associated with each user preference. For example, metadata of a blue shirt may be assigned a higher preference strength than metadata of a red shirt when the user prefers green clothes. If the metadata is related to more than one user preference (e.g., the metadata contains information related to both color and model name), the metadata may be assigned a preference strength based on, e.g., an average of preference strengths, a weighted average of preference strengths, and so on.

In optional S645, the metadata may be prioritized based on the metadata's respective preference strengths. For example, if metadata of two pairs of gloves are identified, wherein one pair of gloves is green and the other pair is red, each metadata is associated with user preference strengths. In this example, the user highly prefers red clothes. The metadata of the green gloves is assigned a preference strength of 4, while the metadata of the red gloves is assigned a preference strength of 9. Accordingly, the metadata of the red gloves is prioritized over the metadata of the green gloves.

In S650, metadata is selected based on the at least one user preference. In an embodiment, metadata is only selected if it has a preference strength above a predefined threshold. In an embodiment, an order of the selected metadata may be based on the prioritization. In a further embodiment, metadata that is low priority is not selected. For example, the metadata selection may only involve selecting the 10 highest priority metadata. In S660, the selected metadata is sent to the user device.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiments and the concepts contributed by the inventor to furthering the art, and are to be construed as being without limitation to such specifically recited examples and conditions. Moreover, all statements herein reciting principles, embodiments, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying metadata for clothing artifacts that appear in multimedia content items, comprising:
generating at least one signature for a received multimedia content item;
identifying at least one matching concept to the multimedia content item, wherein the identification is based on signature matching between the at least one generated signature and a plurality of concept signatures representing a concept;
matching each concept signature to previously generated signatures associated with clothing artifacts; and
identifying, for each clothing artifact signature, metadata associated with the clothing artifact signature.

2. The method of claim 1, wherein generating at least one signature respective of the multimedia content item further comprises:
identifying at least one multimedia element in the multimedia content item, wherein each identified multimedia element contains a potential clothing artifact; and
generating a signature for each identified multimedia element.

3. The method of claim 2, wherein each identified multimedia element further contains a body part that is in proximity to the potential clothing artifact.

4. The method of claim 1, wherein the metadata includes at least one of: commercial data, and visual data.

5. The method of claim 4, wherein the visual data includes at least one of: a color of a clothing artifact, a size of a clothing artifact, and a model name of a clothing artifact.

6. The method of claim 4, wherein the commercial data includes at least one of: data regarding where to buy a clothing artifact, a price associated with a clothing artifact, and a clothing artifact brand.

7. The method of claim 1, wherein the at least one generated signature is robust to noise and distortion.

8. The method of claim 1, wherein the at least one multimedia content item is any of: an image, a graphic, a video stream, a video clip, a video frame, and a photograph.

9. The method of claim 1, wherein identifying, for each clothing artifact signature, metadata associated with the clothing artifact signature further comprises:
identifying at least one user preference; and
selecting metadata based on the identified at least one user preference.

10. The method of claim 1, further comprising:
querying a deep-content classification (DCC) system to identify the at least one matching concept, wherein each of the at least one matching concept is a collection of signatures representing a multimedia element and metadata describing the at least one concept, wherein further each of the at least one matching concept is represented by a concept signature; and
upon identifying the at least one matching concept, returning each concept signature of the at least one matching concept.

11. The method of claim 10, wherein the at least one concept is determined to match a multimedia content item when the concept signature of the concept matches at least one signature generated for the multimedia content item above a predefined threshold.

12. A non-transitory computer readable medium having stored thereon instructions for causing one or more processing units to execute the method according to claim 1.

13. A system for identifying metadata for clothing artifacts that appear in multimedia content items, comprising:
a processing unit;
a memory connected to the processing unit, wherein the memory contains instructions that, when executed by the processing unit, configure the system to:
generate at least one signature for a received multimedia content item;
match concept to the multimedia content item, wherein the identification is based on signature matching between the at least one generated signature and a plurality of concept signatures representing a concept;
match each concept signature to previously generated signatures associated with clothing artifacts; and
identify, for each clothing artifact signature, metadata associated with the clothing artifact signature.

14. The system of claim 13, wherein the system is further configured to:
identify at least one multimedia element in the multimedia content item, wherein each identified multimedia element contains a potential clothing artifact; and
generate a signature for each identified multimedia element.

15. The system of claim 14, wherein each identified multimedia element further contains a body part that is in proximity to the potential clothing artifact.

16. The system of claim 13, wherein the metadata includes at least one of: commercial data, and visual data.

17. The system of claim 16, wherein the visual data includes at least one of: a color of a clothing artifact, a size of a clothing artifact, and a model name of a clothing artifact.

18. The system of claim 16, wherein the commercial data includes at least one of: data regarding where to buy a clothing artifact, a price associated with a clothing artifact, and a clothing artifact brand.

19. The system of claim 13, wherein the at least one generated signature is robust to noise and distortion.

20. The system of claim 13, wherein the at least one multimedia content item is any of: an image, a graphic, a video stream, a video clip, a video frame, and a photograph.

21. The system of claim 13, wherein the system is further configured to:
identify at least one user preference; and
select metadata based on the identified at least one user preference.

22. The system of claim 13, wherein the system is further configured to:
query a deep-content classification (DCC) system to identify the at least one matching concept, wherein each of the at least one matching concept is a collection of signatures representing a multimedia element and metadata describing the at least one concept, wherein further each of the at least one matching concept is represented by a concept signature; and
upon identifying at least one matching concept, return each concept signature of the at least one matching concept.

23. The system of claim 22, wherein the at least one concept is determined to match a multimedia content item when the concept signature of the concept matches at least one signature generated for the multimedia content item above a predefined threshold.
